(19) United States
(12) Patent Application Publication
(10) Pub. No.: US 2013/0246523 A1
(43) Pub. Date: Sep. 19, 2013

(54) BROWSER BASED RECOVERY DISCOVERY

(71) Applicant: Amol P. Gokhale, Pune (IN)

(72) Inventor: Amol P. Gokhale, Pune (IN)

(73) Assignee: SunGard Availability Services LP, Wayne, PA (US)

(21) Appl. No.: 13/422,084

(22) Filed: Mar. 16, 2012

(51) Int. Cl. G06F 15/16

(52) U.S. Cl. 709/204

(57) ABSTRACT

Services that support recovery of a data center require collecting information concerning the service customer's physical and virual infrastructure. Here an automatic discovery tool executes within the context of a secure browser program. Once a user is authenticated, a JavaScript or HTML program seamlessly retrieves configuration data (such as by invoking WMI scripts) forwards that data (such as via an XML file) to the replication service provider so that they may then correctly provision recovery systems.

### BACKGROUND OF THE INVENTION

Replication of data processing systems to maintain operational continuity is now required almost everywhere. The costs incurred during downtime when information technology equipment and services are not available can be significant, and sometimes even cause an enterprise to halt operations completely. Replication may be used for many purposes such as assuring data availability upon equipment failure, site disaster recovery or planned maintenance operations.

Replication may be directed to either the physical or virtual processing environment and/or different abstraction levels. For example, one may undertake to replicate each physical machine exactly as it exists at a given time. However, replication processes may also be architected along virtual data processing lines, with corresponding virtual replication processes, with the end result being to remove the physical boundaries and limitations associated with particular physical machines.

Use of a replication service as provided by a remote or hosted external service provider can have numerous advantages. Replication services can provide continuous availability and failover capabilities that are more cost effective than an approach which has the data center operator owning, operating and maintaining a complete suite of duplicate machines at its own data center. With such replication services, physical or virtual machine infrastructure is replicated at a remote and secure data center.

A database file is typically developed with an entry for the critical data processor in the production environment. The database file may contain configuration information so that in the event of a disaster, replica(s) of the customer's production environment can be brought live at the remote and secure data center. Applications and data can then be accessed on the remote data center, enabling the service customer to continue operating from the “cloud” while recovering from a disaster. From the perspective of the service customer, the replication service provider thus offers a Recover to Cloud (R2C) service that is provided as an on-demand utility (much like the electricity grid) over a network (typically the Internet). This enables a data center operator to replicate critical servers and applications in his production environment to the cloud.

### SUMMARY

Thus there is a need to discover aspects of the configuration of a customer's production environment in order to support disaster recovery. The infrastructure elements of the production environment may include, servers, databases, work stations and each of these may directed to physical and/or virtual processing machines.

It is possible to discover this information manually, such as by providing a series of questions to be answered by an administrative user. However this approach can be tedious, slow to implement, and is prone to errors.

Some vendors provided automated tools in the form of special applications that can be used to discover machine configuration. However, the use of these automated tools is undesirable from the perspective of some replication service customers. These include:
it is still a time consuming process for the administrative user to locate and download the correct software for each data processing system;
reluctance on the part of some customers to download third party software into their production environment for security reasons; and
such software is generally tailored for purposes other than disaster recovery and therefore introduces other difficulties.

In general, the present disclosure is directed to a tool for automating the discovery of configuration information in connection with provisioning a recovery system. A Configuration Management System (or CMS) assists human operators with collecting configuration data. One of the functions performed by the CMS is to periodically obtain configuration information concerning the customer's production environment which may include a number of data processing infrastructure elements such as, but not limited to networking devices, physical machines, virtual machines, storage systems, servers, operating systems and applications. The infrastructure elements thus have a live, running configuration state that is exposed to and can be queried automatically via the CMS. The CMS can store this information in a configuration survey database for later retrieval and use in configurating a recovery environment in the event of a failure of the customer's production environment. The automatically discovered information may be augmented with manually entered information.

In a specific preferred implementation, an administrative user of a replication service uses a secure browser program from within the customers production environment to connect to a secure website hosted by the replication service provider. The secure website authenticates the user and then downloads a browser-based discovery software program such as a JavaScript program to the user's browser.

The browser based discovery program then in turn invokes further functions. For example, host name(s) and login credential(s) for one or more data processors in the customer's production environment are first collected.

The JavaScript can then leverage a resource such a Windows Management Instrumentation (WMI) which is a trusted part of the Windows operating system (or other similar interface) through which instrumented components of the production environment will respond with configuration information. For example, the JavaScript code may use the credentials to automatically connect to each machine in the production environment, and collect configuration information such as host name, manufacturer, model, physical memory, operating system (OS) and OS version, local storage, installed applications and so forth that are necessary to replicate the machine.

The data collected is then formatted and forwarded, such as via an XML file, to the replication service provider so that it can be stored in the configuration database. The configuration database is then accessed to provision replication resources in the event that recovery of the production environment is necessary.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a diagram of a replication service environment operating a recover to cloud service for multiple customers, and a specific customer production environment.

FIG. 2 is a more detailed flow diagram showing a browser based configuration discovery process according to the teachings herein.

FIG. 3 is a JavaScript listing for one implementation using Windows Management Instrumentation (WMI) to access surveyed machine configuration information.

### DETAILED DESCRIPTION

A description of example embodiments follows.

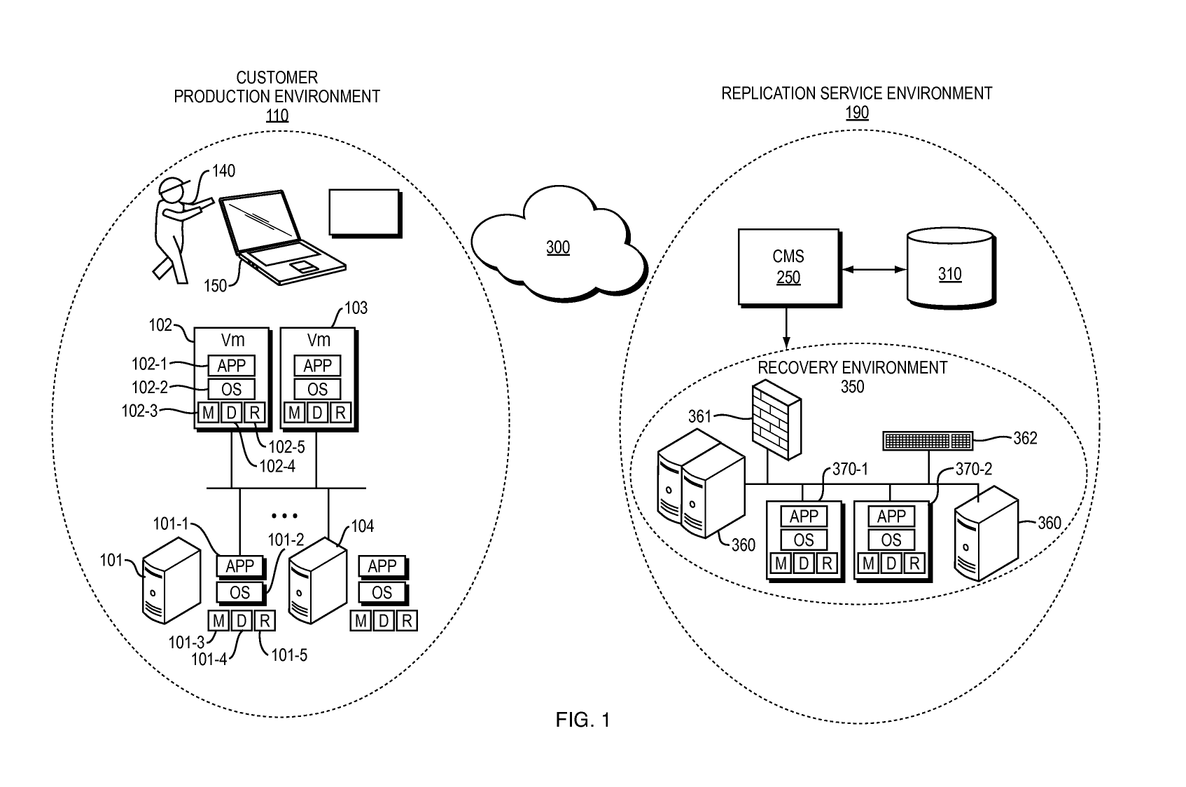

FIG. 1 is a high level block diagram of an environment in which apparatus, systems, and methods for automatically discovering respective configuration information for servers in a production environment so that the configuration information may be automatically discovered in connection with offering a Recover to Cloud (R2C) service.

As shown, a production side environment 110 (that is, the customer's side from the perspective of a replication service provider) includes a number of data processing machines such as servers 101, 102, . . . , 104. The production servers may be physical machines 101 . . . 104 or virtual machines (VMs) 102 . . . 103. An administrator node 150 provides access to an administrator to access a browser-based configuration discovery tool as described below in more detail.

The production servers 101 . . . 104 may implement any sort of data processing function, such as a web server, database server, application server, media server, etc.—the specific end use of the servers is typically not important. An example physical machine 101 is a server that has an application program 101-1, operating system 101-2, memory 101-3, local storage 101-4, and other resources 101-5 such as network connections, etc. An example VM 102 may also include an application 102-1, operating system 102-2, memory 102-3, local data 102-4 and other resources 102-5.

One or more of the production servers 101 . . . 104 may include a replication agent process (not shown in FIG. 1) that performs replication operations. The replication agents detect changes in the production environment 110 and report them to a replication service environment 190. More specifically, the production servers 101 . . . 104 are connected to a wide area network (WAN) connection 300 such as provided by the Internet, a private network or other network to a replication service environment 190 that provides one or more data centers as a recovery environment 350.

The service customer does not really care where or how the recovery environment is implemented, and so from the customer's perspective, is are located at the service provider environment 190 and accessible in the network 300 cloud somewhere to provide a Recover to Cloud (R2C) service.

The recovery environment may make extensive use of virtual machines to replicate the physical and virtual machines in the production environment 110. In such a virtualized computing environment with virtual machines operating in a cloud recovery environment 350, multiple computation stacks, including operating system, middleware, and applications, can operate together in a single server or set of servers. The cloud system(s) are therefore virtualized environments where virtual machines can elastically and dynamically scale to match the load or performance demands, where access to the cloud service is through a public network, and where the number and capability of virtual machines can be measured by the cloud provider and made available to the specifications of the customer using the cloud according to Service Level Agreements or other contractual arrangements.

At a time of disaster (ATOD) (or at time of disaster test (ATOT)), one or more configuration files are retrieved from a configuration database 310 by a Configuration Management System (CMS) 250 and are transferred to one or more on-demand active physical machines 360 or active virtual machines 370 in a failover environment 350 forming part of the replication service environment 190. The failover environment 350 is also accessible to the customer via the cloud 300, preferably through a secure network connection such as may be provided by firewalls 361 or secure Virtual Local Area Networks (VLANs) 362. The specific mechanism(s) for replication and disaster recovery are not of particular importance to the present disclosure. It should also be understood that there may be a number of additional data processors and other elements of a commercial replication service such as recovery systems, storage systems, monitoring and management tools that are not shown in detail in FIG. 1, which are not needed to be specified in detail to understand the present embodiments.

In order to determine the attributes of the physical 360 and virtual 370 machines in the recovery environment, a survey tool may run on administrative node 150 and automatically discover at least some configuration information for the elements of the production environment 110. The configuration information may include identification of server(s), applications, storage, security and network device information for production environment 110. The discovered configuration information is then sent to the CMS 250 and stored in database 310 for use in bringing the recovery environment on line.

More particularly, an administrative user 140 uses an administrative node 150 which is typically located within the customer production environment 110. The administrative user invokes a secure browser program to run a configuration discovery tool on node 150. This may be provided by a secure application server website, hosted by CMS 250 in the replication service environment 190. The discovery tool then automatically collects configuration information from the machines 101 . . . 104 in the customers production environment 110.

Information collected by the configuration discovery tool is forwarded back to the CMS 250. As explained above, the CMS 250 includes a storage device for storing this information, preferably taking the form of a configuration database 260. The database 260 stores several different types of information concerning the customer production environment 110 used to create the replication environment 250. Of particular interest here is that the database 260 stores configuration snapshots consisting of live configuration information taken from and relating to the various infrastructure elements in the customer production environment 110.

The CMS 250 may itself be located in the same physical location as the recovery environment 350, elsewhere the premises of the service provider, at the premises of the customer production environment 110, or remotely located and securely accessing through either a private network or the Internet 112.

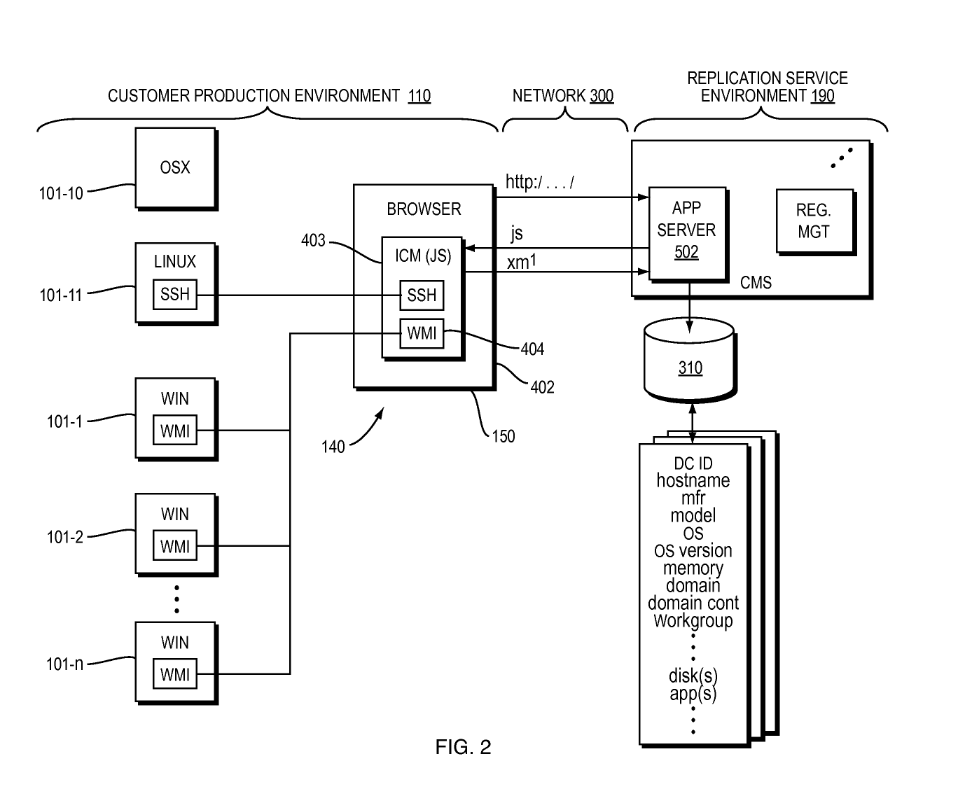

A specific implementation of the browser based discovery tool is shown in more detail in FIG. 2. Here the administrative user 140 at customer production environment 110 runs a secure browser program such as Microsoft Internet Explorer. The user 140 sends a connection request to access an application server 502 that is within the confines of the CMS 250 operated by the replication service provider. In one example, the user sends a request to connect to a specific Uniform Resource Locator (URL) for the application server 502 using HyperText Transfer Protocol Secure (https) over the Internet 300.

The administrative user may next be asked to authenticate with the application server 502 using login credentials. Upon successful authentication, the application server 502 then returns a browser executable program such as a JavaScript program 403 to browser 402 (the JavaScript program 403 is the browser-based discovery program discussed above) over the secure connection.

In a next step, the JavaScript program 403 then executes.

A first step is to obtain configuration information for one or more of the machines 101 in the production environment 110 that are to be included in the recovery environment 350. The machines 101 may be physical machines or virtual machines. This access information may be obtained by the administrative user 140 entering an Internet Protocol (IP) address, user name, and password information for each such machine 101.

Next, the JavaScript program 403 then invokes another secure tool to obtain configuration information from instrumented components in the customer production environment 110. One such tool in the Windows environment is Windows Management Instrumentation (WMI) 404. If the administrative node 150 and machines 101 are each executing a version of Windows (such as Windows 95 or more recent), WMI is available as a pre-installed driver extention of the operating systems of both the administrative node 150 on which the browser 150 is running, as well as each of the Windows-based machines 101-1, 101-2, . . . , 101-n in the customer's production environment.

The browser program 403 can then invoke WMI calls to survey each of the machines 101 to obtain configuration information. The specific configuration information collected depends upon the attributes exposed through WMI 404. These attributes may include, but are not limited to, machine manufacturer, model number, operating system, operating system version, system memory, applications installed and so forth. It will be understood that any configuration information exposed to WMI by each machine 101 can be collected in this manner, and these are but a few examples.

The results of the survey of the various machines 101 in customer production environment 110 is a report automatically generated by the browser tool 403. This report can be formatted appropriately (such as an XML file) and sent securely back to the application server 502 in the replication service provider environment 190. The report can be stored in database 310 and the information retrieved by a resource management process which controls allocation of resources to the recovery environment.

In other instances where the customer production environment 190 includes non-Windows machines it may be possible to use other approaches. In the case of an Apple OSX 101-10 or Linux machine 101-11, a secure shell (SSH) connection may be provided instead of the WMI interface. In this case it might be necessary to install custom mechanisms in the Apple or Linux machine to respond to the query from the JavaScript tool 403.

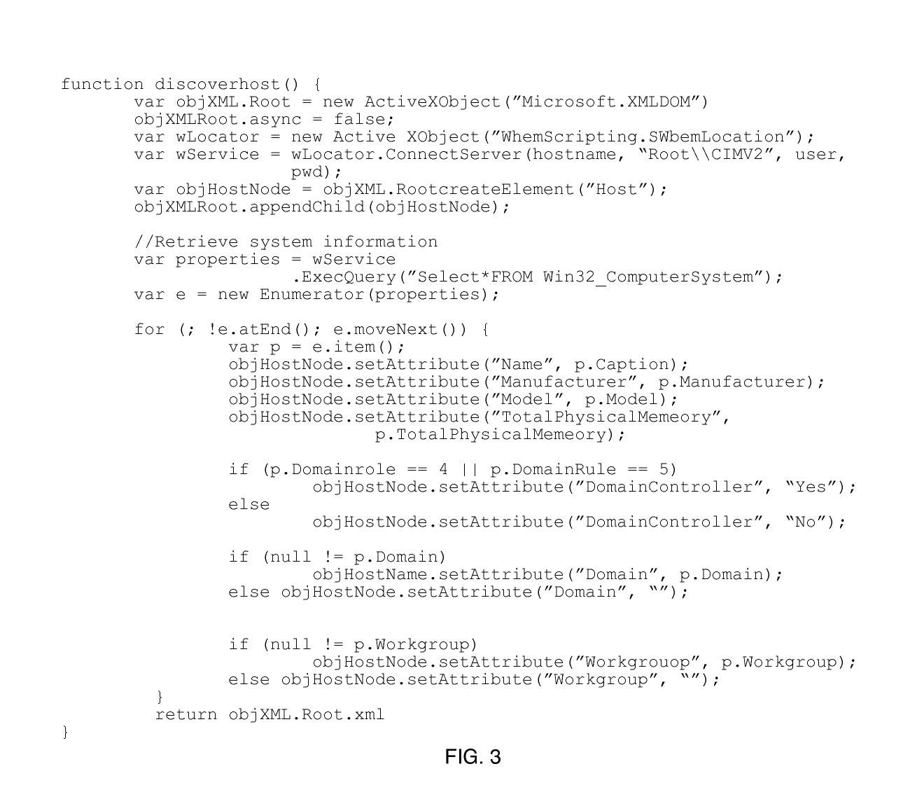

FIG. 3 is an example code listing of a JavaScript function “discoverhost( )” that can be used to invoke the WMI call to discover host information for Windows compatible machines 101.

After defining WMI scripting services, a list of Hosts and corresponding hostnames, user names (“user”), and corresponding passwords (“pwd”) is entered by an administrative user.

Each host is then accessed to obtain a Name, Manufacturer, Model, and TotalPhysicalMemory configuration information. A test is then executed to retrieve a DomainRole attribute, to determine if the machine is operating as a DomainController, Domain, or Workgroup member. The collected information is then returned as an XML file to the CMS 250 in the final step.

It should be understood that the example embodiments described above may be implemented in many different ways. In some instances, the various “data processors” described herein may each be implemented by a physical or virtual general purpose computer having a central processor, memory, disk or other mass storage, communication interface(s), input/output (I/O) device(s), and other peripherals. The general purpose computer is transformed into the processors and executes the processes described above, for example, by loading software instructions into the processor, and then causing execution of the instructions to carry out the functions described. As is known in the art, such a computer may contain a system bus, where a bus is a set of hardware lines used for data transfer among the components of a computer or processing system. The bus or busses are essentially shared conduit(s) that connect different elements of the computer system (e.g., processor, disk storage, memory, input/output ports, network ports, etc.) that enables the transfer of information between the elements. One or more central processor units are attached to the system bus and provide for the execution of computer instructions. Also attached to system bus are typically I/O device interfaces for connecting various input and output devices (e.g., keyboard, mouse, displays, printers, speakers, etc.) to the computer. Network interface(s) allow the computer to connect to various other devices attached to a network. Memory provides volatile storage for computer software instructions and data used to implement an embodiment. Disk or other mass storage provides non-volatile storage for computer software instructions and data used to implement, for example, the various procedures described herein.

Embodiments may therefore typically be implemented in hardware, firmware, software, or any combination thereof.

The computers that execute the processes described above may be deployed in a cloud computing arrangement that makes available one or more physical and/or virtual data processing machines via a convenient, on-demand network access model to a shared pool of configurable computing resources (e.g., networks, servers, storage, applications, and services) that can be rapidly provisioned and released with minimal management effort or service provider interaction. Such cloud computing deployments are relevant and typically preferred as they allow multiple users to access computing resources as part of a shared marketplace. By aggregating demand from multiple users in central locations, cloud computing environments can be built in data centers that use the best and newest technology, located in the sustainable and/or centralized locations and designed to achieve the greatest per-unit efficiency possible.

In certain embodiments, the procedures, devices, and processes described herein are a computer program product, including a computer readable medium (e.g., a removable storage medium such as one or more DVD-ROM's, CD-ROM's, diskettes, tapes, etc.) that provides at least a portion of the software instructions for the system. Such a computer program product can be installed by any suitable software installation procedure, as is well known in the art. In another embodiment, at least a portion of the software instructions may also be downloaded over a cable, communication and/or wireless connection.

Embodiments may also be implemented as instructions stored on a non-transient machine-readable medium, which may be read and executed by one or more procedures. A non-transient machine-readable medium may include any mechanism for storing or transmitting information in a form readable by a machine (e.g., a computing device). For example, a non-transient machine-readable medium may include read only memory (ROM); random access memory (RAM); magnetic disk storage media; optical storage media; flash memory devices; and others.

Furthermore, firmware, software, routines, or instructions may be described herein as performing certain actions and/or functions. However, it should be appreciated that such descriptions contained herein are merely for convenience and that such actions in fact result from computing devices, processors, controllers, or other devices executing the firmware, software, routines, instructions, etc.

It also should be understood that the block and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical, virtual, cloud computers, and/or some combination thereof, and thus the computer systems described herein are intended for purposes of illustration only and not as a limitation of the embodiments.

Thus, while this invention has been particularly shown and described with references to example embodiments thereof, it will be understood by those skilled in the art that various changes in form and details may be made therein without departing from the scope of the invention as encompassed by the appended claims.

While this invention has been particularly shown and described with references to example embodiments thereof, it will be understood by those skilled in the art that various changes in form and details may be made therein without departing from the scope of the invention encompassed by the appended claims.

What is claimed is:

1. A method for automated configuration detection for elements of a customer production environment that are to be replicated in a replication service environment comprising:
sending a request from a secure browser executing on a node within a customer production environment to a replication service provider application server located within a replication service provider environment, the request for access to an executable survey program;
receiving from the replication service provider access to the executable survey program;
running the executable survey program from within the secure browser, the executable survey program further:
obtaining access information for one or more host machines within the customer production environment;
using the access information for each such host machine to invoke an instrumented component interface to obtain configuration information from the host machine;
storing the configuration information; and
forwarding the configuration information for the one or more host machines to the replication service provider application server.

2. The method of claim 1 wherein an administrative user of a replication service uses the secure browser program from within the customer production environment to the replication service provider application server.

3. The method of claim 2 wherein the application server further authenticates the administrative user before providing access to the executable survey program.

4. The method of claim 1 wherein the executable survey program is a JavaScript program.

5. The method of claim 1 wherein the executable survey program obtains access information comprising one or more of a host name(s) and login credential(s) for one or more data processors in the customer production environment.

6. The method of claim 1 wherein the instrumented component interface is a Windows Management Instrumentation (WMI) component interface.

7. The method of claim 1 wherein the configuration information is returned to the replication service provider as an XML file.

8. The method of claim 1 further comprising:
accessing a configuration database to provision replication resources in the event that recovery of the customer production environment is provisioned.

9. An apparatus for detecting a configuration of a customer production environment containing one or more data processing elements that are replicated in a replication service environment comprising:
an application server, located within a replication service provider environment;
a data processor, located within the customer production environment, for executing a secure browser to
connect to the application server located within the replication service provider environment, and request access to an executable survey program;
receive from the replication service provider access to the executable survey program;
run the executable survey program from within the secure browser, the executable survey program further to:
access information for one or more host machines within the customer production environment;
use the access information for at least one of such host machines to invoke an instrumented component interface to obtain configuration information from the host machine;
store the configuration information; and
forward the configuration information for the one or more host machines to the replication service provider application server.

10. The apparatus of claim 9 wherein the secure browser program further accepts input from an administrative user of the replication service from within the customer production environment.

11. The apparatus of claim 10 wherein the application server further
authenticates the administrative user before providing access to the executable survey program.

12. The apparatus of claim 9 wherein the executable survey program is a JavaScript program.

13. The apparatus of claim 9 wherein the executable survey program is further to:
access information comprising one or more of a host name(s) and login credential(s) for one or more data processors in the customer production environment.

14. The apparatus of claim 9 wherein the instrumented component interface is a Windows Management Instrumentation (WMI) component interface.

15. The apparatus of claim 9 wherein the configuration information is returned to the replication service provider as an XML file.

16. The apparatus of claim 9 further comprising:
a configuration database to provision replication resources in the event that recovery of the customer production environment is provisioned.

17. A programmable computer product for automated configuration detection for elements of a customer production environment that are to be replicated in a replication service environment, the programmable computer product comprising a data processing machine that retrieves instructions from a stored media and executes the instructions, and the instructions for:
sending a request from a secure browser executing on a node within a customer production environment to a replication service provider application server located within a replication service provider environment, the request for access to an executable survey program;
receiving from the replication service provider access to the executable survey program;
running the executable survey program from within the secure browser, the executable survey program further:
obtaining access information for one or more host machines within the customer production environment;
using the access information for each such host machine to invoke an instrumented component interface to obtain configuration information from the host machine;
storing the configuration information; and
forwarding the configuration information for the one or more host machines to the replication service provider application server.
